(19) United States
(12) Patent Application Publication
(10) Pub. No.: US 2026/0105686 A1
(43) Pub. Date: Apr. 16, 2026

(54) SCADA SYSTEM TO WHICH DIGITAL TWIN USING IMAGE ANALYSIS BASED ON ARTIFICIAL INTELLIGENCE IS APPLIED AND CONTROL METHOD THEREOF

(71) Applicant: CIMON Co., Ltd., Yongin-si (KR)

(72) Inventor: Jae Yong CHANG, Seoul (KR)

(73) Assignee: CIMON Co., Ltd., Yongin-si (KR)

(21) Appl. No.: 19/321,747

(22) Filed: Sep. 8, 2025

(30) Foreign Application Priority Data
Sep. 11, 2024 (KR) 10-2024-0123943

(51) Int. Cl. G06T 17/00; G06V 20/52

(52) U.S. Cl. CPC G06T 17/00; G06V 20/52; G06V 2201/07

(57) ABSTRACT

A supervisory control and data acquisition (SCADA) system to which a digital twin using image analysis based on artificial intelligence (AI) is applied and a control method thereof, which performs AI-based image analysis on image information to recognize an object included in the corresponding image information, confirms a specific three-dimensional (3D) digital twin model related to the previously recognized object among a plurality of pre-stored 3D digital twin models, searches for a specific programmable logic controller (PLC) data tag related to the previously confirmed specific 3D digital twin model from a plurality of pre-stored PLC data tags, connects the searched specific PLC data tag to the corresponding specific 3D digital twin model, and applies the PLC data tag collected from a PLC in real time to the corresponding specific 3D digital twin model and displays the specific 3D digital twin model as a SCADA scene.

### CROSS-REFERENCE TO RELATED APPLICATION

This application claims priority to and the benefit of Korean Patent Application No. 10-2024-0123943, filed on Sep. 11, 2024, the disclosure of which is incorporated herein by reference in its entirety.

### BACKGROUND

### 1. Field of the Invention

The present invention relates to a supervisory control and data acquisition (SCADA) system to which a digital twin using image analysis based on artificial intelligence (AI) is applied, and more particularly, to a SCADA system to which a digital twin using image analysis based on AI is applied, which performs AI-based image analysis on image information to recognize an object included in the corresponding image information, confirms a specific three-dimensional (3D) digital twin model related to the previously recognized object among a plurality of pre-stored 3D digital twin models, searches for a specific programmable logic controller (PLC) data tag related to the previously confirmed specific 3D digital twin model from a plurality of pre-stored PLC data tags, connects the searched specific PLC data tag to the corresponding specific 3D digital twin model, and applies the PLC data tag collected from a PLC in real time to the corresponding specific 3D digital twin model and displays the specific 3D digital twin model as a SCADA scene, and a control method thereof.

### 2. Discussion of Related Art

Supervisory control and data acquisition (SCADA) refers to a supervisory control function of a SCADA system, also known as a centralized remote monitoring control system or a supervisory control data acquisition system. The SCADA system refers to a system that collects·receives·records·displays state information data from remote terminal units using analog or digital signals over communication channels, allowing a central control system to monitor and control the remote terminal units, and is a system that centrally monitor and control various types of remote facility devices such as power generation·power transmission and distribution facilities, petrochemical plants, steelmaking facilities, and factory automation facilities.

In order to implement digital twin technology combined with artificial intelligence (AI) image recognition technology in the SCADA system, programmable logic controller (PLC) data tags should be directly connected to an attribute of parts of a three-dimensional (3D) model that are to be monitored and controlled in relation to data. However, this is a considerably difficult task, and it requires a significant amount of time to code logic to connect the PLC data tags to an attribute of the 3D model in a programming language to connect all the tags to the attributes of the 3D model.

In addition, it is difficult to process various industrial facilities, devices, and sensors through coding in an unspecified variable environment. Therefore, problems of a lot of manpower and cost arise.

In addition, there is no method to process through direct coding in a general-purpose SCADA system used by users without basic programming knowledge.

### RELATED ART DOCUMENT

### Patent Document

(Patent literature 1) Korean Patent No. 10-1887384 [Title: SCADA system and operation method thereof]

### SUMMARY OF THE INVENTION

The present invention is directed to providing a supervisory control and data acquisition (SCADA) system to which a digital twin using image analysis based on artificial intelligence (AI) is applied, which performs AI-based image analysis on image information to recognize an object included in the corresponding image information, confirms a specific three-dimensional (3D) digital twin model related to the previously recognized object among a plurality of pre-stored 3D digital twin models, searches for a specific programmable logic controller (PLC) data tag related to the previously confirmed specific 3D digital twin model from a plurality of pre-stored PLC data tags, connects the searched specific PLC data tag to the corresponding specific 3D digital twin model, and applies the PLC data tag collected from a PLC in real time to the corresponding specific 3D digital twin model and displays the specific 3D digital twin model as a SCADA scene, and a control method thereof.

According to an aspect of the present invention, there is provided a supervisory control and data acquisition (SCADA) system to which a digital twin using image analysis based on artificial intelligence (AI) is applied, including a server configured to perform AI-based learning based on image information including one or more facilities located within a preset capturing area to recognize one or more objects included in the image information based on the training results, confirm a specific three-dimensional (3D) digital twin model related to the recognized object among a plurality of pre-stored 3D digital twin models, search for a specific programmable logic controller (PLC) data tag related to the confirmed specific 3D digital twin model among a plurality of pre-stored PLC data tags, connect the searched specific PLC data tag to the confirmed specific 3D digital twin model, generate the digital twin by performing 3D rendering based on the image information and the specific 3D digital twin model to which the specific PLC data tag is connected, and output the generated digital twin to a SCADA scene, and a PLC configured to correspond to one or more facilities included in the image information.

The server may transmit PLC data request information related to the facility to the PLC corresponding to the one or more facilities included in the image information using a predetermined method at a preset cycle, the PLC may collect one or more PLC data tags, each including state information for one or more facilities related to the PLC, based on the PLC data request information, and transmit the collected one or more PLC data tags to the server, and the server may apply the one or more PLC data tags transmitted from the PLC in response to the previously transmitted PLC data request information to the attribute of the corresponding specific 3D digital twin model within the digital twin being output and display the attribute of the specific 3D digital twin model.

According to an aspect of the present invention, there is provided a control method of a SCADA system to which a digital twin using image analysis based on artificial intelligence is applied, including performing, by a server, AI-based learning based on image information including one or more facilities located within a preset capturing area and recognizing one or more objects included in the image information based on the training result, confirming, by the server, a specific 3D digital twin model related to the recognized object among a plurality of pre-stored 3D digital twin models, searching for, by the server, a specific PLC data tag related to the confirmed specific 3D digital twin model among a plurality of pre-stored PLC data tags, connecting, by the server, the searched specific PLC data tag to the confirmed specific 3D digital twin model, generating, by the server, a digital twin by performing the 3D rendering based on the image information and the specific 3D digital twin model to which the specific PLC data tag is connected, and outputting, by the server, the generated digital twin to the SCADA scene.

In the recognizing of the one or more objects included in the image information, the learning may be performed using the image information as an input value of a preset object recognition model, and the one or more objects included in the image information may be recognized based on the training result.

In the connecting of the searched specific PLC data tag to the confirmed specific 3D digital twin model, the searched (or confirmed) specific PLC data tag may be connected to an attribute of the confirmed specific 3D digital twin model using an html document object model (DOM).

The method may further include collecting, by the server, the PLC data tag related to the facility, which is the object, from a PLC corresponding to one or more objects included in the image information, and applying, by the server, the collected PLC data tag related to the facility to the attribute of the specific 3D digital twin model in the digital twin being output and outputting the attribute of the specific 3D digital twin model.

The control method may further include generating, by the server, control information for controlling a specific facility among one or more facilities displayed on the digital twin according to an administrator input, transmitting, by the server, the generated control information to a PLC related to the specific facility, controlling, by the PLC, an operation of the specific facility based on the control information transmitted from the server, and generating a control result and transmitting the generated control result to the server, and displaying, by the server, the control result transmitted from the PLC on one side of the digital twin.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a configuration of a supervisory control and data acquisition (SCADA) system to which a digital twin using image analysis based on artificial intelligence (AI) is applied according to an embodiment of the present invention; and

FIG. 2 is a flowchart illustrating a control method of a SCADA system to which a digital twin using image analysis based on artificial intelligence is applied according to an embodiment of the present invention.

### DETAILED DESCRIPTION OF EXEMPLARY EMBODIMENTS

It is to be noted that technical terms used in the present disclosure are used in order to describe only specific exemplary embodiments rather than restricting the present disclosure. In addition, unless indicated otherwise in the present disclosure, it is to be understood that all the technical terms used in the present disclosure are construed as meaning as those that are generally understood by those who skilled in the art and as excessively comprehensive meanings and excessively reduced meanings. In addition, when the technical terms used in the present disclosure are wrongly technical terms that do not accurately indicate the technical spirit of the present disclosure, it is to be understood that the terms are replaced with the technical terms understood by those skilled in the art. Further, the general terms used in the present invention must be understood according to the terms defined by the dictionary or the context and should not be excessively reduced meanings.

In addition, singular forms used in the present disclosure are intended to include plural forms unless the context clearly indicates otherwise. In the present disclosure, it is to be noted that the terms “configured of”, “including,” or the like, are not be construed as necessarily including several components or several steps described in the present disclosure and some of the above components or steps may not be included or additional components or steps are construed as being further included.

Terms including an ordinal number such as first, second, or the like, used in the present disclosure may be used to describe various components. However, these components are not limited to these terms. Terms are used only in order to distinguish one component from another component. For example, a first component may be named a second component, and similarly, the second component may be named the second component, without departing from the scope of the present invention.

Hereinafter, exemplary embodiments of the present disclosure will be described in detail with reference to the accompanying drawings. The same reference numerals will be used to describe the same or like components, independent of the reference numerals and an overlapped description of the same components will be omitted.

Further, when it is decided that the detailed description of the known art related to the present disclosure may obscure the gist of the present disclosure, the detailed description thereof will be omitted. In addition, it is to be noted that the accompanying drawings are provided only in order to allow the spirit of the present invention to be easily understood and is to be interpreted as limiting the spirit of the present invention.

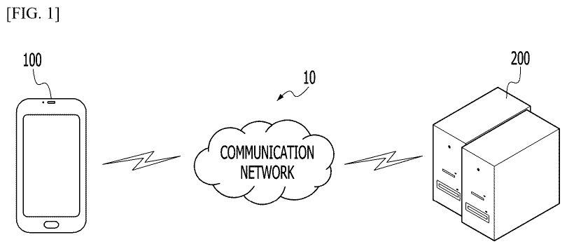

FIG. 1 is a block diagram illustrating a configuration of a supervisory control and data acquisition (SCADA) system 10 to which a digital twin using image analysis based on artificial intelligence (AI) is applied according to an embodiment of the present invention.

As illustrated in FIG. 1, the SCADA system 1 to which a digital twin using image analysis based on AI is applied is composed of a programmable logic controller (PLC) 100 and a server 200. Not all components of the SCADA system 1 to which a digital twin using image analysis based on AI is applied illustrated in FIG. 1 are essential components, and the SCADA system 1 to which a digital twin using image analysis based on AI is applied may be implemented by more components than the components illustrated in FIG. 1, or may be implemented by fewer components.

The server 200 may be implemented in the form of a web server, a database server, a proxy server, etc. In addition, the server 200 may be installed with a network load distribution mechanism or one or more of various types of software that enables the server 200 to operate on the Internet or other networks, and thus may be implemented as a computerized system. In addition, the network may be an http network, a private line, an intranet, or any other network. Furthermore, the connection between the PLC 100 and the server 200 may be connected to a secure network so that data is not attacked by any hacker or other third party. In addition, the server 200 may include a plurality of database servers, and the database servers may be implemented in a manner in which the database servers are separately connected to the server 200 through any type of network connection, including distributed database server architecture.

The PLC 100 and the server 200 may each include a communication unit (not illustrated) for performing a communication function with other terminals, a storage unit (not illustrated) for storing various types of information and programs (or applications), a display unit (not illustrated) for displaying various types of information and program execution results, a voice output unit (not illustrated) for outputting voice information corresponding to the various types of information and program execution results, a control unit (not illustrated) for controlling various components and functions of each terminal, etc.

The PLC 100 communicates with the server 200, etc. Here, the PLC 100 may be matched (or managed/controlled) one-to-one with one or more facilities (not illustrated) equipped (or deployed/installed) in an industrial site, or may be matched with multiple facilities in order to manage multiple facilities.

In addition, the PLC 100 collects (or receives) PLC data tags related to one or more facilities managed by the PLC 100. In this case, the PLC 100 may collect the PLC data tags related to the facility according to a preset cycle, a request of the server 200, etc.

In addition, the PLC 100 provides (or transmits) the PLC data tags related to one or more collected (or received) facilities, identification information of the PLC 100, etc., to the server 200. Here, the identification information of the PLC 100 includes the mobile IP, the mobile MAC, the unique information, the serial number, etc.

In addition, the PLC 100 receives PLC data request information transmitted from the server 200.

In addition, the PLC 100 collects one or more PLC data tags including state information of each facility for one or more facilities related to the PLC 100 based on the received PLC data request information, and transmits the collected one or more PLC data tags, the identification information of the PLC 100, etc., to the server 200. In this case, the PLC data tag including the state information of the facility is composed of various attribute related to the facility, including size, shape, color, rotation, movement, etc. Here, the identification information of the PLC 100 includes the mobile IP, the mobile MAC, the unique information, the serial number, etc.

In addition, the PLC 100 receives control information transmitted from the server 200.

In addition, the PLC 100 controls an operation (or management) of a specific facility based on the received control information, and generates a control result. Here, the control result includes a specific facility name (or facility unique number), control contents, control start time, control end time, etc.

In addition, the PLC 100 transmits the generated control result, the identification information of the PLC 100, etc., to the server 200.

The server 200 communicates with the PLC 100, etc.

In addition, the server 200 performs functions as a central server that performs the overall control function of the SCADA system 10 while installed with SCADA software. Here, the SCADA software may be software used to manage PLC tag data (or tag data) together with software such as human machine interface (HMI) and man machine interface (MMI), and perform a Historian chart creating function using the PLC tag data, a report generation function, etc.

In addition, in the SCADA, the tag (or PLC data tag) represents elements that need to be monitored or controlled in the SCADA.

In addition, the tag (or PLC data tag) is divided into a digital tag and an analog tag.

The digital tag is used to monitor or control an operating state, etc., of a corresponding facility (or apparatus/device) according to a state of one bit data (e.g., high/low), such as an operating state (e.g., run/stop) of a pump or an on state (e.g., on/off) of a lamp.

In addition, the analog tag is used to represent continuously varying quantities, such as a water level, a flow rate, a voltage, and a current, which are converted into multiple bits of data such as byte (8 bits), word (16 bits), or double word (32 bits), to monitor or control an operational state of a facility (or apparatus/device). Here, the analog tag uses most of data within a range of about 5 digits including a decimal point. Since the analog tag should include the decimal point, the analog tag is stored (or managed) in the form of a floating point (double float).

In addition, the server 200 may classify, infer, and monitor the operational integrity of the SCADA system 10 and operator errors of an administrator based on all data managed by the server 200, using an AI-based approach.

In addition, the server 200 may be composed of a main server (not illustrated) and a sub-server (not illustrated).

In this way, when configured in a redundant configuration with the server 200, the server 200 may perform functions such as switching a main server from an activated state (e.g., main server) to a deactivated state, and switching a sub-server from a deactivated state (e.g., sub-server) to an activated state, or vice versa, based on the confirmation result of abnormal state.

In addition, when configured in a redundant configuration with the server 200, the server 200 may simultaneously operate the main server and the sub-server by considering an operating rate (or CPU occupancy rate) of the server 200.

In addition, the server 200 manages a 3D digital twin model applied to a digital twin. Here, the server 200 applies a supervised learning algorithm of AI to the 3D digital twin models, stores the 3D digital twin models to be recognized, and manages the 3D digital twin models by organizing the 3D digital twin models into a library.

That is, the server 200 trains a 3D digital twin model (or 3D object), which is pre-classified, through the supervised learning in the image recognition learning engine (or object recognition model to recognize objects on the server 200. Internally, the image recognition learning engine (or 3D engine) is rotated from multiple angles to capture and store the required images, thereby enabling the training that the target is an object to be recognized. When the training is completed, the 3D objects are stored in a library managed by the server 200 (or a database (not illustrated)), and are configured to be rendered in the scene when the image is recognized.

In addition, the 3D digital twin model learned by the server 200 uses convolution neural networks (CNNs) as the AI image recognition technology algorithm to find a matching model in the library where the 3D digital twin model is stored for the object (or entity) recognized in the image.

In addition, the server 200 utilizes a plurality of pieces of image information, etc., collected in advance as data for continuous learning (or machine learning/deep learning). Here, the input dataset for training may be divided into a training set and a test set, in a predetermined ratio (including, for example, 7:3 or 8:2) using the plurality of image information and the like, so as to perform training and testing functions. In addition, the input data set for training includes the plurality of pieces of image information, etc., collected later. In addition, the output data set for training includes one or more objects (or facilities), etc., included in the corresponding image information, which are parts to be predicted, and are learned according to the plurality of pieces of image information, etc., and predicted later.

That is, the server 200 performs a training function to recognize (or classify/confirm) objects (or facilities) included in individual image information in relation to the corresponding image information, etc., according to the corresponding plurality of image information, etc., in relation to specific raw data through preset training data for an object recognition model (or an object classification/prediction model). In this case, the server 200 stores raw data (or including the plurality of pieces of image information, etc.) in parallel and in a distributed manner, refines unstructured data, structured data, and semi-structured data included in the stored raw data (or including training data, etc.), performs preprocessing including classification as metadata, performs analysis including data mining on the preprocessed data, and performs learning, training, and testing based on at least one type of machine learning, thereby building big data. In this case, at least one type of machine learning may be composed of one or at least one of supervised learning, semi-supervised learning, unsupervised learning, reinforcement learning, and deep reinforcement learning. The data mining may include performing classification to predict a class of new data by training a train data set whose class is known by exploring the inherent relationship between preprocessed data, or performing clustering to group data based on similarity without class information.

In this way, the server 200 performs a training function for the object recognition model (or object classification/prediction model) in the form of a neural network or an artificial neural network through the training data, etc.

In addition, the server 200 collects image information including one or more facilities located within a preset capturing area. In this case, the preset capturing area (or capturing area) may be any area (or zone) within a preset industrial site (e.g., including a factory, power generation system, etc.).

That is, a camera unit (not illustrated), which manages (or covers) the industrial site (or capturing area), acquires (or captures) image information including one or more facilities located within the capturing area, and transmits (or provides) the acquired (or captured) image information, the identification information of the camera unit, etc., to the server 200. Here, the identification information of the camera unit includes the mobile IP, the mobile MAC, the unique information, the serial number, etc. In this case, the PLC 100 may be matched (or managed/controlled) with one or more facilities one-to-one, or may be matched with multiple facilities.

In addition, the server 200 receives (or collects) the image information including one or more facilities transmitted from the camera unit, the identification information of the camera unit, etc.

In addition, the server 200 performs training (artificial neural network/machine learning/deep learning) for AI-based image analysis on the collected image information, and recognizes (or classifies/confirms) one or more objects (or facilities) included in the corresponding image information based on the training result.

That is, the server 200 performs training (or artificial intelligence/machine learning/deep learning) using the collected image information, etc., as input values of a preset object recognition model (or object classification/prediction model), and recognizes (or classifies/confirms) one or more objects (or facilities) included in the corresponding image information based on the training result (or artificial intelligence result/machine training result/deep training result). In this case, the server 200 performs the preprocessing (or preprocessing function) on the collected image information, and then performs the AI-based learning on the preprocessed image information (or image information on which the preprocessing function has been performed), and may recognize (or classify/confirm) one or more objects (or facilities) included in the corresponding image information based on the training result. Here, the preprocessing function includes a function for removing unnecessary areas (including, for example, borders, etc.) from the corresponding image information, a function for adjusting brightness (or luminance adjustment function), a function for adjusting sharpness, a function for adjusting creasing, a function for removing glare, etc.

In addition, when one or more objects are not recognized in the corresponding image information, the server 200 displays (or outputs) information indicating that the corresponding image information does not include an object.

In addition, the server 200 confirms a specific 3D digital twin model (or one or more 3D digital twin models) related to the recognized object (or one or more objects) from among a plurality of 3D digital twin models pre-stored in the corresponding server 200 (or a library within the corresponding server 200/database (not illustrated)).

In the embodiment of the present invention, for the convenience of description, the recognized object is described as one, but it is not limited thereto, and when the server 200 recognizes a plurality of objects from the corresponding image information, the server 200 may confirm individual 3D digital twin models corresponding to each of the plurality of recognized objects among the plurality of 3D digital twin models pre-stored in the corresponding server 200.

In addition, the server 200 searches for (or confirms) a specific PLC data tag (or one or more PLC data tags) related to the confirmed specific 3D specific twin model (or one or more 3D digital twin models) among the plurality of PLC data tags pre-stored in the server 200 (or another library in the server 200/database).

In addition, the server 200 connects (or matches/maps) the searched (or confirmed) specific PLC data tag to the confirmed specific 3D digital twin model.

That is, the server 200 connects (or matches/maps) the searched (or confirmed) PLC data tag to the attribute of the confirmed specific 3D specific twin model (or “<3D BODY>” of the confirmed specific 3D specific twin model) using the HTML DOM. Here, the server 200 may define the name of the specific PLC data tag and the name of each part of the specific 3D digital twin model in a pre-arranged (or set) format in order to connect the specific PLC data tag to the attribute of each part of the specific 3D digital twin model. In this case, the attribute of the specific 3D digital twin model includes location, rotation, color, size, light source, etc., and may be set in various ways according to the designer's design, and may be set differently for each 3D digital twin model.

In addition, the server 200 generates (or implements/configures) a digital twin (or a 3D digital twin/digital twin environment) by performing 3D rendering based on the image information, the specific 3D digital twin model to which the specific PLC data tag is connected, etc.

In addition, the server 200 outputs (or displays) the generated (or implemented/configured) digital twin (or the digital twin to which the specific 3D digital twin model corresponding to one or more objects included in the corresponding image information is applied) to the SCADA scene (or SCADA application/software execution result scene) through the preset 3D engine. In this case, the server 200 may output the generated digital twin to an app execution result scene (or the SCADA scene) on preset SCADA software.

In the embodiment of the present invention, the generation of the digital twin is mainly described in relation to one preset capturing area of the corresponding industrial site, but is not limited thereto, and the server 200 may also configure the digital twin for the entire (or part) of the corresponding industrial site by performing the above processes based on the plurality of pieces of image information collected from each of the plurality of capturing areas related to the corresponding industrial site.

In addition, the server 200 collects (or receives) the PLC data tags related to the facility, which is an object, from the PLC 100 corresponding to one or more objects included in the corresponding image information using the predetermined method (e.g., including JavaScript, etc.) at the preset cycle.

That is, the server 200 transmits PLC data request information related to a facility to the PLC 100 corresponding to one or more facilities (or objects) included in the corresponding image information using the predetermined method (e.g., including JavaScript, etc.) at the preset cycle.

In addition, the server 200 receives the one or more PLC data tags, the identification information of the PLC 100, etc., transmitted from the PLC 100 in response to the previously transmitted PLC data request information.

In addition, the server 200 applies (or reflects/updates) the collected (or received) PLC data tags related to the corresponding facility to the attribute of the corresponding specific 3D digital twin model in the digital twin being output, using the html DOM, and displays (or outputs) the collected PLC data tags. In this case, the server 200 may accurately display the on-site situation as a scene that is easier to understand and more convenient to understand through changes in size, shape, color, rotation, movement, animation, etc., of the specific 3D digital twin model within the digital twin based on the PLC data tag related to the collected facility.

In this way, the server 200 may recognize the learned 3D digital twin model using the AI image analysis algorithm, automatically display the corresponding object in the SCADA system (or the SCADA scene), and automatically connect the tag connected to the attribute of the 3D digital twin model.

Through this, as the data connection method for dynamic change of the digital twin used in the existing industrial field, the data of the PLC 100 may be obtained by an automatic connection method of a tag, rather than a method of coding or manual work, so the changed animation by real-time data of the digital twin may be conveniently implemented.

In addition, the SCADA system 10 may be expected to reduce development manpower. That is, if the present invention is not adopted, developers with advanced programming skills would have to write code to develop a program that links PLC data tags with digital twin models. There are numerous and various equipment, facilities, and environments in the field, and a huge amount of development manpower is required to program all of these individually, but this may be solved through the configuration of the present invention.

In this way, the SCADA system 10 may be expected to save time and cost. That is, developing a program, coding, and implementing a function requires a lot of development manpower, and thus incurs costs. In addition, there are countless unspecified industrial fields, and there are so many types of equipment, facilities, and sensors used in the field. When all of these are developed according to the situation at that time, it takes a huge amount of time, and the cost increases proportionally. However, when the technical features of the present invention are used, this burden may be reduced.

In this way, the SCADA system 10 may accurately analyze and monitor the situation of the field by constructing the SCADA system using the artificial intelligence image recognition and 3D digital twin technology. It is difficult to express tag data from various sensors and measuring devices in the field controlled by the PLC 100 with image recognition alone. Therefore, the image recognition should be integrated with the digital twin technology to accurately capture the changes in data values, movements of equipment, and hidden internal changes that may not be identified through image alone, thereby enabling effective control and monitoring of the site.

In addition, the server 200 generates control information for controlling a specific facility from among one or more facilities displayed on the corresponding digital twin according to administrator input (or administrator/user selection/touch/control).

That is, after the specific 3D digital twin model is selected from among one or more 3D digital twin models included in the digital twin displayed on the corresponding server 200, the server 200 receives the input value (or the setting value) according to the administrator input.

In addition, the server 200 generates the control information (or control signal) including information on the selected specific 3D digital twin model (or information on a facility related to the specific 3D digital twin model), the received input value (or a setting value), etc.

In addition, the server 200 transmits the generated control information to the PLC 100 related to the specific facility.

In addition, the server 200 receives the control result transmitted from the PLC 100, the identification information of the PLC 100, etc., in response to the previously transmitted control information.

In addition, the server 200 displays (or outputs) the received control result, etc., on one side of the digital twin.

In addition, the server 200 may perform various functions (e.g., a 3D digital twin model creation and management function, a digital twin creation and management function, the communication function with a PLC, a PLC data tag collection function from a PLC, a function of applying the collected PLC data tag to the digital twin, etc.) by using the scene (or the SCADA scene) related to the corresponding SCADA software in the form of a dedicated app or a website.

As described above, the AI-based image analysis may be performed on the image information to recognize the object included in the corresponding image information, the specific 3D digital twin model related to the previously recognized object may be confirmed from among the plurality of pre-stored 3D digital twin models, the PLC data tag related to the previously confirmed specific 3D digital twin model may be searched from the plurality of pre-stored PLC data tags, the searched specific PLC data tag may be connected to the corresponding specific 3D digital twin model, and the PLC data tag collected in real time from the PLC may be applied to the corresponding specific 3D digital twin model to displays the specific 3D digital twin model as the SCADA scene.

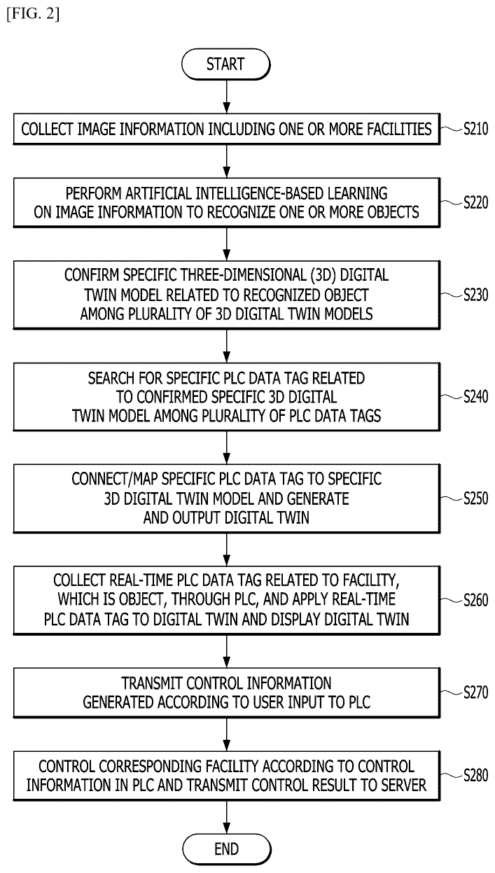

Hereinafter, a control method of a SCADA system to which a digital twin using image analysis based on AI is applied according to the present invention will be described in detail with reference to FIGS. 1 and 2.

FIG. 2 is a flowchart illustrating a control method of a SCADA system to which a digital twin using image analysis based on artificial intelligence (AI) is applied according to an embodiment of the present invention.

First, the server 200 collects image information including one or more facilities located within a preset capturing area (or capturing zone).

That is, a camera unit (not illustrated), which manages (or covers) the industrial site (or capturing area), acquires (or captures) image information including one or more facilities located within the capturing area, and transmits (or provides) the acquired (or captured) image information, the identification information of the camera unit, etc., to the server 200. Here, the identification information of the camera unit includes the mobile IP, the mobile MAC, the unique information, the serial number, etc. In this case, the PLC 100 may be matched (or managed/controlled) with one or more facilities one-to-one, or may be matched with multiple facilities.

In addition, the server 200 receives (or collects) the image information including one or more facilities transmitted from the camera unit, the identification information of the camera unit, etc.

For example, the server 200 collects first image information including a first generator and a first pump obtained from a first camera unit (not illustrated) covering a first capturing area in preset factory A (S210).

Thereafter, the server 200 performs training (artificial neural network/machine learning/deep learning) for AI-based image analysis on the collected image information, and recognizes (or classifies/confirms) one or more objects (or facilities) included in the corresponding image information based on the training result.

That is, the server 200 performs training (or artificial intelligence/machine learning/deep learning) using the collected image information, etc., as input values of a preset object recognition model (or object classification/prediction model), and recognizes (or classifies/confirms) one or more objects (or facilities) included in the corresponding image information based on the training result (or artificial intelligence result/machine training result/deep training result). In this case, the server 200 performs the preprocessing (or preprocessing function) on the collected image information, and then performs the AI-based learning on the preprocessed image information (or image information on which the preprocessing function has been performed), and may recognize (or classify/confirm) one or more objects (or facilities) included in the corresponding image information based on the training result. Here, the preprocessing function includes a function for removing unnecessary areas (including, for example, borders, etc.) from the corresponding image information, a function for adjusting brightness (or luminance adjustment function), a function for adjusting sharpness, a function for adjusting creasing, a function for removing glare, etc.

For example, the server 200 performs training using the collected first image information, etc., as the input value of the object recognition model, and recognizes the first generator and the first pump included in the first image information based on the training result (S220).

Thereafter, the server 200 confirms a specific 3D digital twin model (or one or more 3D digital twin models) related to the recognized object (or one or more objects) among the plurality of 3D digital twin models pre-stored in the corresponding server 200 (or a library within the corresponding server 200/database (not illustrated)).

For example, the server 200 confirms an eleventh 3D digital twin model corresponding to the recognized first generator and a twenty-first 3D digital twin model corresponding to the recognized first pump from among the plurality of 3D digital twin models pre-stored in the server 200 (S230).

Thereafter, the server 200 searches for (or confirms) the specific PLC data tag (or one or more PLC data tags) related to the confirmed specific 3D specific twin model (or one or more 3D digital twin models) from among the plurality of PLC data tags pre-stored in the server 200 (or another library in the server 200/database).

For example, the server 200 searches for the eleventh PLC data tag related to the confirmed eleventh 3D digital twin model from among the plurality of PLC data tags pre-stored in the server 200, and searches for the twenty-first PLC data tag related to the confirmed twenty-first 3D digital twin model (S240).

Thereafter, the server 200 connects (or matches/maps) the searched (or confirmed) specific PLC data tag to the confirmed specific 3D digital twin model.

That is, the server 200 connects (or matches/maps) the searched (or confirmed) PLC data tags to the attribute of the confirmed specific 3D specific twin model (or “<3D BODY>” of the confirmed specific 3D specific twin model) using the HTML DOM. Here, the server 200 may define the name of the specific PLC data tag and the name of each part of the specific 3D digital twin model in a pre-arranged (or set) format in order to connect the specific PLC data tag to the attribute of each part of the specific 3D digital twin model. In this case, the attribute of the specific 3D digital twin model includes location, rotation, color, size, light source, etc., and may be set in various ways according to the designer's design, and may be set differently for each 3D digital twin model.

In addition, the server 200 generates (or implements/configures) a digital twin (or a 3D digital twin/digital twin environment) by performing 3D rendering based on the image information, the specific 3D digital twin model to which the specific PLC data tag is connected, etc.

In addition, the server 200 outputs (or displays) the generated (or implemented/configured) digital twin (or the digital twin to which the specific 3D digital twin model corresponding to one or more objects included in the corresponding image information is applied) to the SCADA scene through the preset 3D engine. In this case, the server 200 may output the generated digital twin to an app execution result scene (or the SCADA scene) on preset SCADA software.

For example, the server 200 connects the searched eleventh PLC data tag to each of the plurality of attributes of the eleventh 3D digital twin model using the html DOM, and connects the searched twenty-first PLC data tag to each of the plurality of attributes of the twenty-first 3D digital twin model.

In addition, the server 200 generates the first digital twin based on the first image information, the eleventh 3D digital twin model connected to the eleventh PLC data tag, the twenty-first 3D digital twin model connected to the twenty-first PLC data tag, etc.

In addition, the server 200 displays the first digital twin generated in relation to the first capturing area within the factory A on the SCADA scene (S250).

Thereafter, the server 200 collects (or receives) the PLC data tags related to the facility, which is an object, from the PLC 100 corresponding to one or more objects included in the corresponding image information using the predetermined method (e.g., including JavaScript, etc.) at the preset cycle.

That is, the server 200 transmits PLC data request information related to a facility to the PLC 100 corresponding to one or more facilities (or objects) included in the corresponding image information using the predetermined method (e.g., including JavaScript, etc.) at the preset cycle.

In addition, the PLC 100 receives PLC data request information transmitted from the server 200.

In addition, the PLC 100 collects one or more PLC data tags including state information of each facility for one or more facilities related to the PLC 100 based on the received PLC data request information, and transmits the collected one or more PLC data tags, the identification information of the PLC 100, etc., to the server 200. In this case, the PLC data tag including the state information of the facility is composed of various attributes related to the facility, including size, shape, color, rotation, movement, etc. Here, the identification information of the PLC 100 includes the mobile IP, the mobile MAC, the unique information, the serial number, etc.

In addition, the server 200 receives the one or more PLC data tags, the identification information of the PLC 100, etc., transmitted from the PLC 100 in response to the previously transmitted PLC data request information.

In addition, the server 200 applies (or reflects/updates) the collected (or received) PLC data tags related to the corresponding facility to the attribute of the corresponding specific 3D digital twin model in the digital twin being output, using the html DOM, and displays (or outputs) the collected PLC data tags. In this case, the server 200 may accurately display the on-site situation as a scene that is easier to understand and more convenient to understand through changes in size, shape, color, rotation, movement, animation, etc., of the specific 3D digital twin model within the digital twin based on the PLC data tag related to the collected facility.

For example, the server 200 collects a real-time 101st PLC data tag related to the first generator and a real-time 102nd PLC data tag related to the first pump, respectively, by linking with a first PLC 100 that manages the first generator and the first pump included in the corresponding first image information.

In addition, the server 200 uses the html DOM to apply the collected real-time 101st PLC data tag to the attribute of the eleventh 3D digital twin model related to the first generator included in the first digital twin, and apply the collected real-time 102nd PLC data tag to the attribute of the twenty-first 3D digital twin model related to the first pump and displays the attribute of the eleventh 3D digital twin model and the attribute of the twenty-first 3D digital twin model (S260).

Thereafter, the server 200 generates control information for controlling a specific facility from among one or more facilities displayed on the corresponding digital twin according to the administrator input (or administrator/user selection/touch/control).

That is, after the specific 3D digital twin model is selected among one or more 3D digital twin models included in the digital twin displayed on the corresponding server 200, the server 200 receives the input value (or the setting value) according to the administrator input.

In addition, the server 200 generates the control information (or control signal) including information on the selected specific 3D digital twin model (or information on a facility related to the specific 3D digital twin model), the received input value (or a setting value), etc.

In addition, the server 200 transmits the generated control information to the PLC 100 related to the specific facility.

For example, the server 200 generates first control information for controlling an operating state of the first generator related to the eleventh 3D digital twin model displayed on the first digital twin according to the first administrator input.

In addition, the server 200 transmits the generated first control information to the first PLC related to the first generator (S270).

Thereafter, the PLC 100 receives control information transmitted from the server 200.

In addition, the PLC 100 controls an operation (or management) of a specific facility based on the received control information, and generates a control result. Here, the control result includes a specific facility name (or facility unique number), control contents, control start time, control end time, etc.

In addition, the PLC 100 transmits the generated control result, the identification information of the PLC 100, etc., to the server 200.

In addition, the server 200 receives the control result transmitted from the PLC 100, the identification information of the PLC 100, etc., in response to the previously transmitted control information.

In addition, the server 200 displays (or outputs) the received control result, etc., on one side of the digital twin.

For example, the first PLC receives the first control information transmitted from the server 200 and controls the operating state of the first generator based on the received first control information.

In addition, the first PLC generates a first control result according to an operating state control of the first generator and transmits the generated first control result, identification information of the first PLC, etc., to the server 200.

In addition, the server 200 receives the first control result, the identification information of the first PLC, etc., transmitted from the first PLC in response to the first control information previously transmitted, etc.

In addition, the server 200 displays the received first control result on one side of the scene where the first digital twin is displayed (S280).

As described above, an embodiment of the present invention may perform the AI-based image analysis on the image information to recognize the object included in the corresponding image information, confirm the specific 3D digital twin model related to the previously recognized object among the plurality of pre-stored 3D digital twin models, search for the specific PLC data tag related to the previously confirmed specific 3D digital twin model from the plurality of pre-stored PLC data tags, connect the searched specific PLC data tag to the corresponding specific 3D digital twin model, and apply the PLC data tag collected from the PLC in real time to the corresponding specific 3D digital twin model and displays the specific 3D digital twin model as the SCADA scene, thereby expecting the reduction in development manpower resources, expecting the reduction in time and cost, and accurately analyzing and monitoring the site situations.

The above-described content can be modified and changed by a person having ordinary skill in the art to which the present disclosure pertains without departing from the essential characteristics of the present disclosure. Accordingly, exemplary embodiments disclosed in the present disclosure are not to limit the spirit of the present disclosure, but are to describe the spirit of the present disclosure. The scope of the present disclosure is not limited to these exemplary embodiments. The scope of the present invention should be interpreted by the following claims and it should be interpreted that all spirits equivalent to the following claims fall within the scope of the present invention.

What is claimed is:

1. A supervisory control and data acquisition (SCADA) system to which a digital twin using image analysis based on artificial intelligence (AI) is applied, comprising:
a server configured to perform AI-based learning based on image information including one or more facilities located within a preset capturing area to recognize one or more objects included in the image information based on the training results, confirm a specific three-dimensional (3D) digital twin model related to the recognized object among a plurality of pre-stored 3D digital twin models, search for a specific programmable logic controller (PLC) data tag related to the confirmed specific 3D digital twin model among a plurality of pre-stored PLC data tags, connect the searched specific PLC data tag to the confirmed specific 3D digital twin model, generate the digital twin by performing 3D rendering based on the image information and the specific 3D digital twin model to which the specific PLC data tag is connected, output the generated digital twin to a SCADA scene, collects a PLC data tag related to a facility, which is the object, from a PLC corresponding to one or more objects included in the image information, and apply the PLC data tag related to the collected facility to an attribute of the specific 3D digital twin model within the digital twin being output and output the attribute of the specific 3D digital twin; and
a PLC configured to correspond to one or more facilities included in the image information.

2. The SCADA system of claim 1, wherein the server transmits PLC data request information related to the facility to the PLC corresponding to the one or more facilities included in the image information using JavaScript, which is a predetermined method, at a preset cycle,
the PLC collects one or more PLC data tags, each including state information for one or more facilities related to the PLC, based on the PLC data request information, and transmits the collected one or more PLC data tags to the server, and
the server applies the one or more PLC data tags transmitted from the PLC in response to the previously transmitted PLC data request information to the attribute of the corresponding specific 3D digital twin model within the digital twin being output and displays the attribute of the specific 3D digital twin model.

3. A control method of a supervisory control and data acquisition (SCADA) system to which a digital twin using image analysis based on artificial intelligence (AI) is applied, comprising:
performing, by a server, AI-based learning based on image information including one or more facilities located within a preset capturing area and recognizing one or more objects included in the image information based on the training result;
confirming, by the server, a specific 3D digital twin model related to the recognized object among a plurality of pre-stored 3D digital twin models;
searching for, by the server, a specific PLC data tag related to the confirmed specific 3D digital twin model among a plurality of pre-stored PLC data tags;
connecting, by the server, the searched specific PLC data tag to the confirmed specific 3D digital twin model;
generating, by the server, a digital twin by performing the 3D rendering based on the image information and the specific 3D digital twin model to which the specific PLC data tag is connected;
outputting, by the server, the generated digital twin to the SCADA scene;
collecting, by the server, a PLC data tag related to the facility, which is the object, from a PLC corresponding to the one or more objects included in the image information; and
applying, by the server, the PLC data tag related to the collected corresponding facility to an attribute of the specific 3D digital twin model within the digital twin being output and outputting the attribute of the specific 3D digital twin model.

4. The control method of claim 3, wherein, in the recognizing of the one or more objects included in the image information, the learning is performed using the image information as an input value of a preset object recognition model, and the one or more objects included in the image information are recognized based on the training result.

5. The control method of claim 3, wherein, in the connecting of the searched specific PLC data tag to the confirmed specific 3D digital twin model, the searched specific PLC data tag is connected to an attribute of the confirmed specific 3D digital twin model using an html document object model (DOM).

6. The control method of claim 3, further comprising:
generating, by the server, control information for controlling a specific facility among one or more facilities displayed on the digital twin according to an administrator input;
transmitting, by the server, the generated control information to a PLC related to the specific facility;
controlling, by the PLC, an operation of the specific facility based on the control information transmitted from the server, and generating a control result and transmitting the generated control result to the server; and
displaying, by the server, the control result transmitted from the PLC on one side of the digital twin.
